(19) United States
(12) Patent Application Publication
(10) Pub. No.: US 2004/0068046 A1
(43) Pub. Date: Apr. 8, 2004

(54) Coating with a negligible solar absorption

(76) Inventor: Gerd Hugo, Schondorf (DE)

Correspondence Address: Nath & Associates, Sixth Floor, 1030 15th Street NW, Washington, DC, 20005, US

(21) Appl. No.: 10/466,756

(22) PCT Filed: Jan. 18, 2002
(86) PCT No.: PCT/DE02/00147

(30) Foreign Application Priority Data
Jan. 22, 2001 (DE) 101 02 789.3

(51) Int. Cl. C08L 1/00

(52) U.S. Cl. 524/556; 524/543

(57) ABSTRACT

The invention relates to a coating, which has greater reflective properties than conventional colours in the non-visible ranges of the solar spectrum, i.e. in the ultra-violet and in the near infra-red range, and thus absorbs less solar energy.

Surfaces which are darkly coloured or coated for technical or aesthetic reasons and which are exposed to sunlight heat up to a greater or lesser extent depending on the depth of their colour.

In our surroundings, particularly in smaller spaces such as, for example, in a vehicle, be it a car, a lorry, a bus or even the interiors of trains, the heating up of dark surfaces by solar energy is extremely disagreeable. The dark surfaces heat up to a greater or lesser extent depending on their degree of solar absorption and release their heat into the interior as heat radiation. This heat must then be compensated by means of an air conditioning system, which considerably increases the energy consumption of the vehicle.

There are surfaces in a vehicle which have to be darkly coloured for technical reasons. The dashboard of a car is a good example. If the dashboard were to have a light colour, it would reflect in the windscreen and hinder the driver's view of the road. It is thus necessary for it to be darkly coloured. Since this surface lies directly under the windscreen, it is the most exposed to solar rays and heats up accordingly. In addition to the disagreeable heating up of the vehicle, the intense warming of the dark surfaces naturally also leads to a quicker material fatigue of the concerned surfaces.

For aesthetic reasons, leather seats in cars are primarily designed in dark grey tones, usually even in black. If such a vehicle stands in the sun for a period of time and if the leather seats are exposed to sunlight, they heat up so much that it is almost impossible to sit on them.

The solar heating of dark steering wheels is even more disagreeable since they usually have to be touched with bare hands.

In general, darkly coloured surfaces in closed rooms having windows are particularly problematic since the windows are transparent in the wavelength range of solar irradiation, i.e. from below 300 nm to 2500 nm. They therefore let almost all solar energy in. A considerable part of the solar energy is absorbed by conventional, dark surfaces. The surfaces heat up and then, according to the temperature reached, reflect the energy again in the long wave infrared range at wavelengths of 5 to over 50 μm.

However, windows are no longer transparent in the long wave infrared range and thus the absorbed solar energy remains trapped in the room. It would, however, be desirable even with dark surfaces, to reflect part of the solar energy so that this part of the energy can return to the outside via the window.

In the United States of America, the roofs of residential buildings are mainly covered with bitumen shingles. Darker colours such as grey or green are preferred here. Owing to the high position of the sun even in the northern states of the USA and to the mostly low insulation standard, a lot of solar energy is trapped by the dark roofs which must again be compensated by air conditioning systems.

Furthermore, in contrast to the wall colours used in southern Europe, which are mostly white, the wall colours used in the USA are darker earth tones. As is the case with the roofs, this also contributes to an intense heating of the houses.

However, light and even while wall colours also have quite a noteworthy solar absorption in the ultraviolet and near infrared ranges of sunlight and thus heat up noticeably. It would be desirable, particularly in hot countries, to have an outer wall colour with as little solar absorption as possible.

In U.S. Pat. No. 5,540,998, a “solar heat-shielding coating” is presented. A coating arrangement is described herein which has a higher reflection of sunlight in the near infrared range. The disadvantage here is that the arrangement must consist of two layers otherwise it will not work.

A white layer having high solar reflection is required as the first or base layer. An achromatic black colour formed of coloured pigments is then applied to this layer.

The disadvantage here is not only that two layers generally have to be applied to achieve a dark surface having low solar absorption, but also that if damage occurs to the dark outer layer, a white layer then appears. The appearance of white surfaces is inconceivable for many areas of use such as, for example, for a dark dashboard surface in a car, and leads to the entire coating arrangement becoming useless.

The object of the present invention is to provide a coating which has a higher reflection than normal colours in the invisible ranges of the solar spectrum, i.e. in the ultraviolet and near infrared range, and thus absorbs less solar energy.

This object is solved according to the invention by means of a coating with a negligible solar absorption, comprising

a) a binding agent and/or a combination of binding agents which have a transparency of greater than 60% in the wavelength range of ultraviolet and visible light and in the near infrared wavelength range, i.e. 300 to 2500 nm, and which have a transparency of less than 70% in the thermal infrared wavelength range of 5 to 50 μm.

b) first pigments which have a transparency of greater than 70% in the wavelength range of 300 to 2500 nm, the particle size of which is selected in such a way that they have a backscattering of greater than 70% in the near infrared wavelength range of 700 to 1500 nm, and which have an absorption of greater than 40% in the thermal infrared range of 5 to 50 μm.

c) second pigments which absorb spectral-selectively in the visible light wavelength range of 400 to 700 nm and/or absorb more than 50% in the entire visible light wavelength range of 400 to 700 nm, and which have a transparency of greater than 50% in the near infrared wavelength range of 700 to 1500 nm and have an absorption of greater than 40% in the thermal infrared range of 5 to 50 μm.

d) and/or third pigments which absorb spectral-selectively in the spectral range of visible light of 400 to 700 nm and/or absorb more than 50% in the entire visible light wavelength range of 400 to 700 nm, and which are reflective themselves in the near infrared spectral range with a reflection of greater than 50% and have an absorption of greater than 40% in the thermal infrared range of 5 to 50 μm.

e) fillers for reducing the refractive index of the binding agent matrix consisting of hollow microspheres filled with a gas or air and/or air pockets in the binding agent, the particle and/or air pocket sizes of which are selected such that they have a low backscattering of less than 70% in the visible light wavelength range of 400 to 700 nm, that the backscattering of the first pigments increases by 10% in the near infrared wavelength range of 700 to 1500 nm, and which have an absorption of greater than 40% in the thermal infrared range of 5 to 50 μm.

Advantageous developments of the inventive idea can be seen from the sub-claims. An advantageous development of the inventive idea is that the binding agent is selected from

a) the group of solvent-containing binding agents which includes acrylates, styrene acrylates, polyvinyls, polystyrenes and styrene copolymers, alkyd resins, saturated and unsaturated polyesters, hydroxide functional polyesters, melamine formaldehyde resins, polyisocyanate resins, polyurethanes, epoxide resins, fluoropolymers and silicones, chlorosufonated polyethylenes, fluorinated polymers, fluorinated acryl copolymers, fluorosilicones, plastisols, PVDF and mixtures hereof.

b) the group of aqueous binding agents which includes the group of water-soluble binders of alkyds, polyesters, polyacrylates, epoxides and expoxide esters, from the group of aqueous dispersions and emulsions which includes dispersions and emulsions on the basis of acrylate, styrene acrylate, ethylene acrylic acid copolymers, methacrylate, vinylpyrrolidone vinyl acetate copolymers, polyvinyl pyrrolidones, polyisopropyl acrylate, polyurethane, silicone, wax dispersions on the basis of polyethylene, polypropylenes, Teflon®, synthetic waxes, fluorinated polymers, fluorinated acryl copolymer in an aqueous solution, fluorosilicones and mixtures hereof.

An advantageous development of the inventive idea is that the binding agent has a transparency of greater than 70% in the visible light wavelength range of 300 to 700 nm and a transparency of less than 60% in the thermal infrared wavelength range of 5 to 50 μm.

An advantageous development of the inventive idea is that the first pigments are selected from the group of inorganic pigments, from the group of metal oxides, metal sulphates, metal sulphides, metal fluorides, metal silicates, metal carbonates and mixtures hereof.

An advantageous development of the inventive idea is that the first pigments are selected from the group of degradable materials selected from calcium carbonate, magnesium carbonate, zirconium silicate, zirconium oxide, aluminium oxide, natural barium sulphate and mixtures hereof, and that the refraction index of the first pigments is greater than 1.5, preferably greater than 1.7, with the particle size of the first pigments being between 0.9 and 3.1 μm, in particular 2 μm.

An advantageous development of the inventive idea is that the second pigments are selected from the group of organic pigments, selected from the group of azo pigments, selected from monoazo pigments, disazo pigments, β-naphtol pigments, naphtol AS pigments, coated azo pigments, benzimidazolone pigments, disazo condensation pigments, metal complex pigments, isoindolinone and isoindoline pigments, selected from the group of polycyclic pigments, selected from phthalocyanine pigments, quinacridone pigments, perylene and perinone pigments, thioindigo pigments, anthraquinone pigments, anthrapyrimidine pigments, flavanthrone pigments, pyranthrone pigments, anthanthrone pigments, dioxazine pigments, triaryl carbonium pigments, quinophthalone pigments, and diketopyrrolopyrrol pigments.

A further advantageous development of the inventive idea is that the third pigments are selected from the group of inorganic pigments, selected from the group of metal oxides and hydroxides, in particular iron oxides, from cadmium, bismuth, chromium, ultramarine and iron blue pigments, from the group of rutile and spinel mixed phase pigments and coated, lamellar mica pigments.

An advantageous development of the inventive idea is that the particle size of the third pigments is between 0.7 and 2.9 μm, in particular between 0.9 and 1.8 μm.

An advantageous development of the inventive idea is that the fillers are hollow microspheres made of an organic and/or inorganic material which has a transparency of greater than 70% in the wavelength range of 300 to 1500 nm, and that the particle size of the hollow microspheres is between 10 and 100 μm, in particular between 20 and 40 μm, with the hollow microspheres being advantageously selected from plastic and/or glass.

It has furthermore proven advantageous for the development of the inventive idea to select hollow microspheres of plastic which are present in an aqueous suspension and which form a hollow space following drying, with the particle size of these hollow microspheres being between 0.3 and 1 μm.

A further advantageous development of the inventive idea is that the reflection of the coating in the near infrared wavelength range of 800 to 1100 nm is consistently greater than 60% or, particularly advantageously, is consistently greater than 70% in this wavelength range.

An advantageous development of the inventive idea is that the reflection of the coating in the visible light wavelength range of 400 to 700 nm is less than 70%, preferably less than 60% and particularly preferred less than 50%.

A particularly advantageous development of the inventive idea is that binding agents are selected which result in a water-repellent surface following hardening.

### FIGURES

FIGS. 1 to 6 show curves of hemispheric backscattering for the colour samples as represented in Examples 1 to 5, recorded using a PC-plug-in spectrometer of the firm Avantes having a spectral sensitivity of 320 to 1100 nm and an Ulbricht sphere attached thereto.

### THE SUBJECT MATTER OF THE INVENTION IS EXPLAINED IN MORE DETAIL BELOW USING EXAMPLES

### Example 1

A black colour for plastic surfaces according to the invention was mixed according to the following formulation:

| | |
|---|---|
| 50.00 g | water with 2% Tylose MiH 2000 of the firm Clariant |
| 15.00 g | binding agent U 330 of the firm Alberdingk |
| 15.00 g | binding agent APU 1014 of the firm Alberdingk |
| 05.00 g | ultralube W-874 of the firm Keim Additec |
| 00.20 g | anti-foaming agent Byk 024 |
| 00.20 g | pigment disperser N of the firm BASF |
| 35.00 g | zirconium silicate of the firm Wema having an average particle |
| | size of 2 μm |
| 02.00 g | hollow microspheres Expancel 416 DE 20 of the firm Akzo |
| | Nobel |
| 30.00 g | black colour paste comprised of: |
| | 20 parts Paliogen black L0086 of the firm BASF |
| | 80 parts butyl glycol |
| | 11 parts QWD 0108 Magenta of the firm Sun Chemical |
| 05.00 g | water |

The colour was applied to a common laboratory black/white colour testing card using a coating dumbbell at a layer thickness of 150 μm and was spectrally measured against the black background of the colour testing card in the wavelength range of 400 to 980 nm.

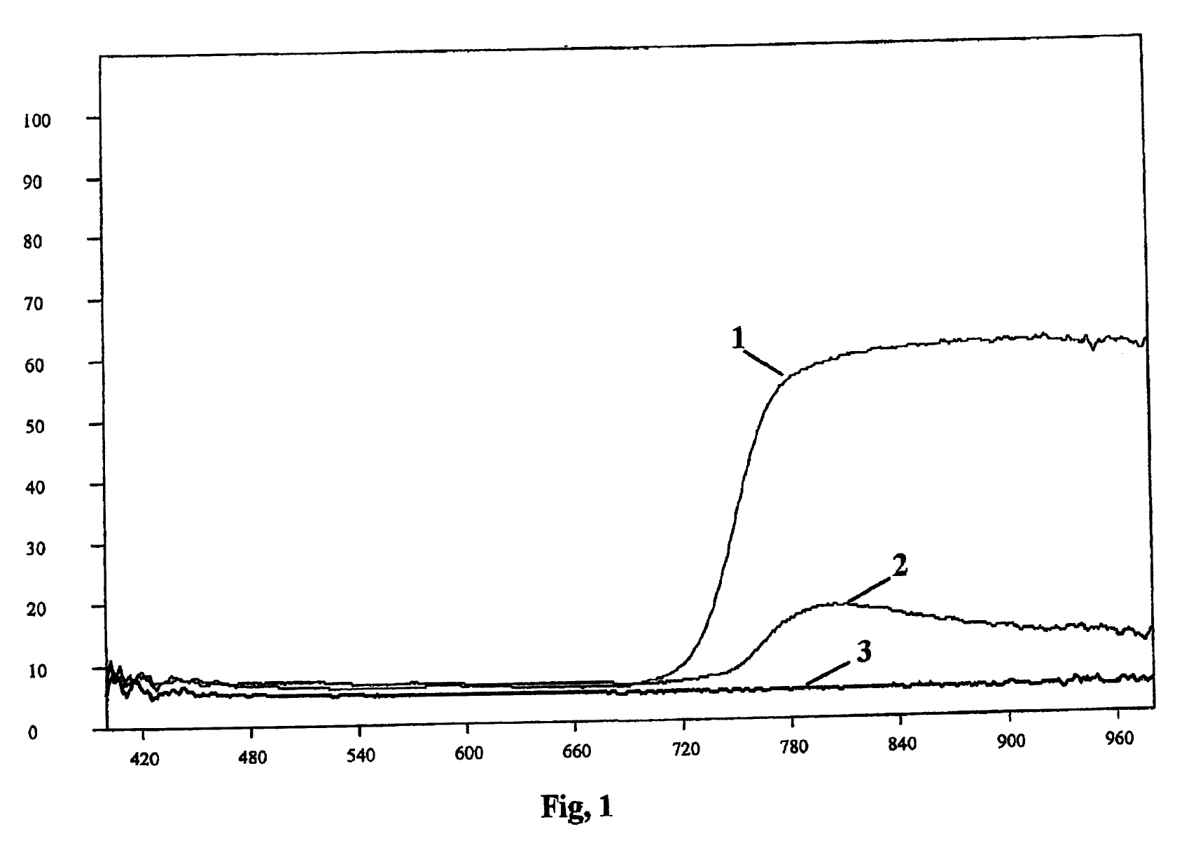

The measurement results are shown as spectral reflection on a scale of 0 to 100% in FIG. 1, curve (1). The increased reflection in the near infrared range is clearly recognisable.

### Comparative Example for 1

An achromatic black colour similar to the colour described in U.S. Pat. No. 5,540,998 was produced as follows in the laboratory:

| | |
|---|---|
| 50.00 g | water with 2% Tylose MH 2000 of the firm Clariant |
| 15.00 g | binding agent U 330 of the firm Alberdingk |
| 15.00 g | binding agent APU 1014 of the firm Alberdingk |
| 00.20 g | anti-foaming agent Byk 024 |
| 00.20 g | pigment disperser N of the firm BASF |
| 02.50 g | Hostatint red FGR of the firm Hoechst (now Clariant) |
| 06.00 g | Hostatint blue B2G of the firm Hoechst (now Clariant) |
| 02.00 g | Hostatint yellow 4GX of the firm Hoechst (now Clariant) |

The colour was applied to a common laboratory black/white colour testing card using a coating dumbbell at a layer thickness of 150 μm and was spectrally measured against the black background of the colour testing card in the wavelength range of 400 to 980 nm.

The measurement results are shown as spectral reflection on a scale of 0 to 100% in FIG. 1, curve (2). The reflection in the near infrared wavelength range is clearly lower than is the case for the black colour according to the invention as per Example 1.

### Further Comparative Example for Example 1

A commercial black colour from the Weilburger Lackfabrik called Senopur Teerschwarz RAL 9021 was applied to a common laboratory black/white colour testing card using a coating dumbbell at a layer thickness of 150 μm and was spectrally measured against the black background of the colour testing card in the wavelength range of 400 to 980 nm.

The measurement results are shown as spectral reflection in FIG. 1, curve (3). Reflection in the near infrared wavelength range just like reflection in the visible range of the spectrum is below 10% and is thus clearly lower than is the case for the black colour according to the invention as per Example 1.

Comparison of Heating During Solar Radiation

Equally sized samples of the colours were stuck on a styropore plate and exposed to solar radiation at 98 000 Lx. The temperatures of the samples were measured using a radiation thermometer. The following temperatures resulted:

| | |
|---|---|
| Black according to the invention | 54° C. |
| Achromatic black | 64° C. |
| Senopur Teerschwarz RAL 9021 | 67° C. |

### Example 2

A brown colour according to the invention was mixed according to the following formulation:

| | |
|---|---|
| 50.00 g | water with 2% Tylose MH 2000 of the firm Clariant |
| 40.00 g | Foraperle 321 of the firm Elf Atochem |
| 00.20 g | anti-foaming agent Byk 024 |
| 00.20 g | pigment disperser N of the firm BASF |
| 05.00 g | Ecopaque red 12302 of the firm Heubach |
| 05.00 g | PK 4047 green of the firm Ferro |
| 10.00 g | Diafil 525 of the firm CR Minerals USA |
| 20.00 g | zirconium silicate of the firm Wema having an average particle |
| | size of 2 μm |
| 01.50 g | hollow microspheres Expancel 461 DE 20 of the firm Akzo |
| | Nobel |

The colour was applied to a common laboratory black/white colour testing card using a coating dumbbell at a layer thickness of 150 μm and was spectrally measured against the black background of the colour testing card in the wavelength range of 400 to 980 nm.

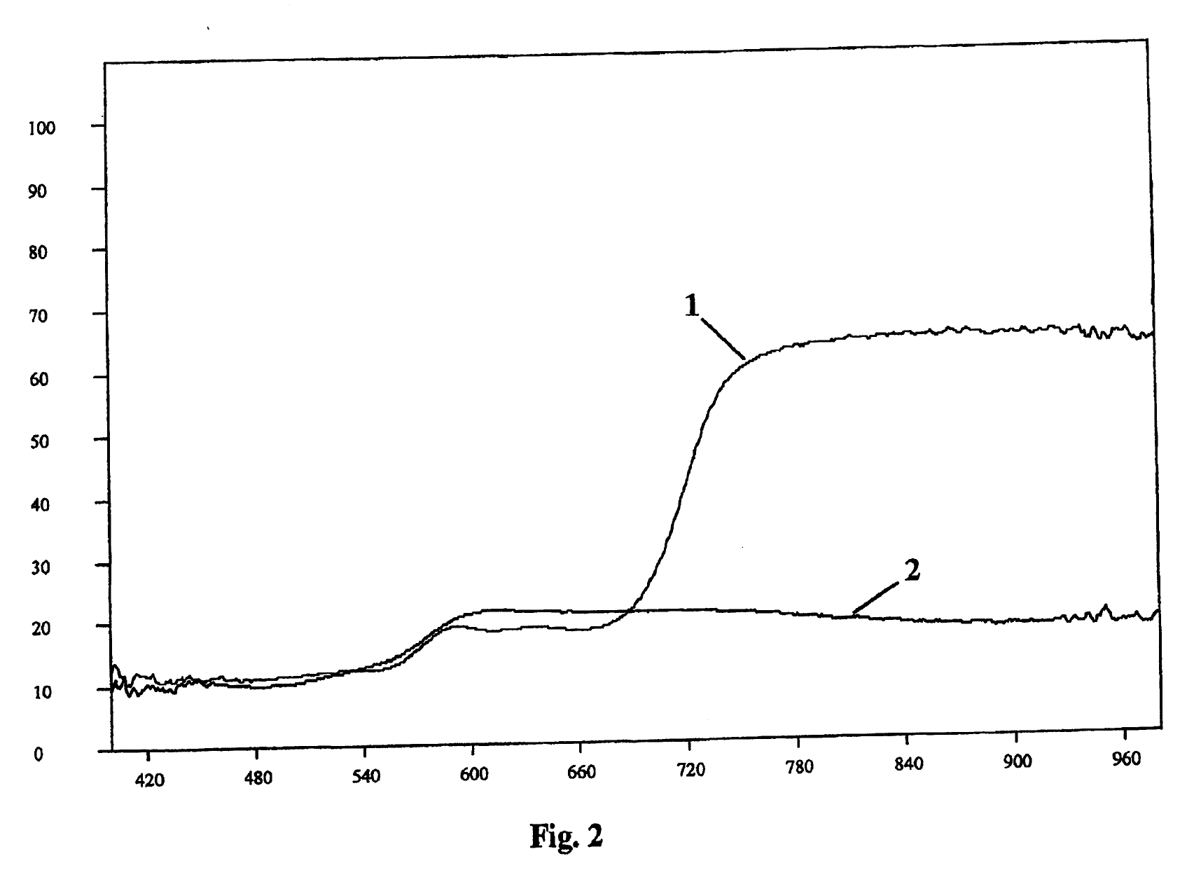

The measurement results are shown as spectral reflection on a scale of 0 to 100% in FIG. 2, curve (1). The increased reflection in the near infrared range is clearly recognisable.

### Comparative Example for 2

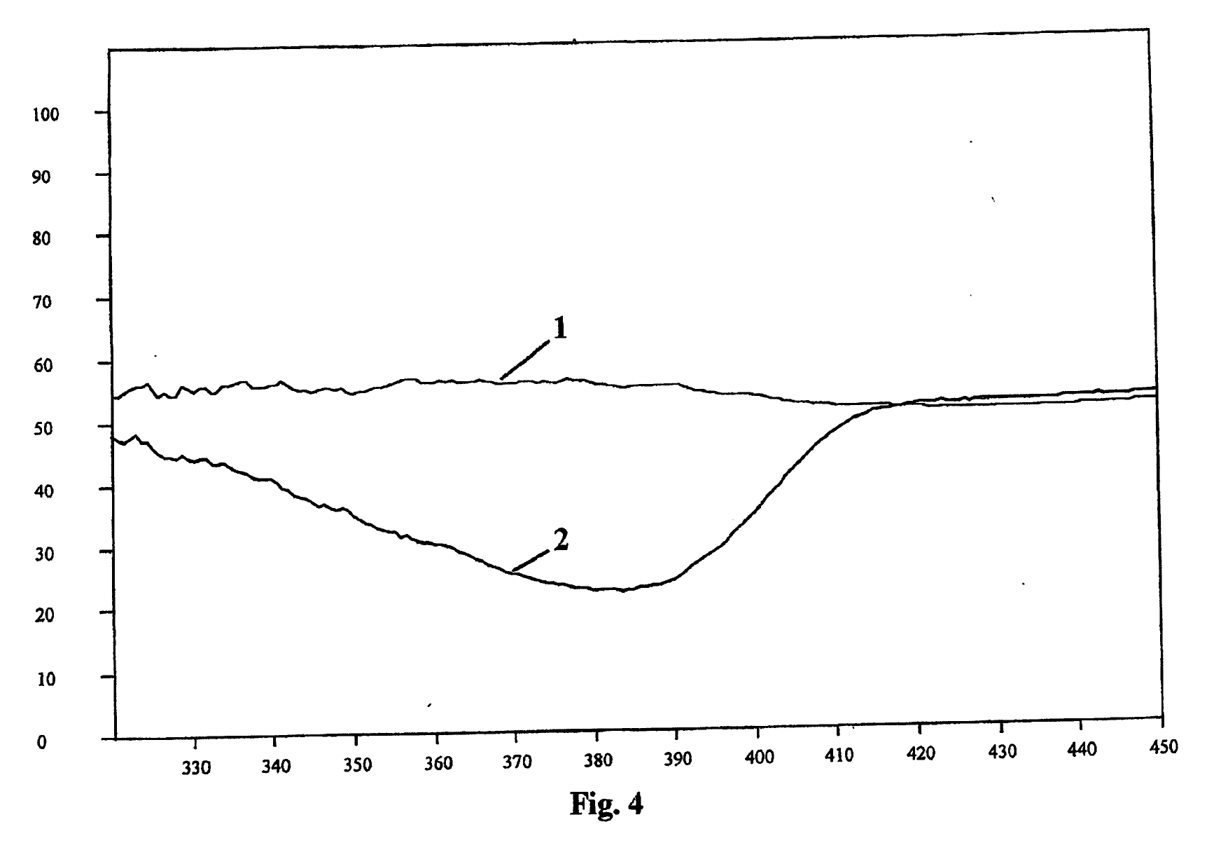

The colour chart of a commercial wall colour of the firm Sonneborn USA having the colour tone Abiquiu brown was spectrally measured in the wavelength range of 400 to 980 nm. The measurement results are shown in FIG. 2, curve (2). They show a clearly lower reflection in the near infrared range than is the case for the brown colour according to the invention in FIG. 4. This colour clearly heats up more than the brown colour according to the invention when exposed to solar radiation.

### Example 3

A green colour according to the invention was mixed according to the following formulation:

| | |
|---|---|
| 50.00 g | water with 2% Tylose MH 2000 of the firm Clariant |
| 50.00 g | binding agent Mowilith DM 771 of the firm Hoechst |
| 05.00 g | Copo wax dispersion 312 W of the firm Coating Products |
| 00.40 g | anti-foaming agent Byk 024 |
| 00.40 g | pigment disperser N of the firm BASF |
| 25.00 g | zirconium silicate of the firm Wema having an average particle |
| | size of 2 μm |
| 20.00 g | Calcilit 16G of the firm Aplha Calcit |
| 12.00 g | PK 4047 green of the firm Ferro |
| 10.00 g | PK 3080 black of the firm Ferro |
| 15.00 g | water |
| 02.00 g | hollow microspheres S 22 of the firm 3M |

The colour was sprayed onto a grey bitumen shingle of the firm Vedaform using a spray gun and was spectrally measured in the wavelength range of 400 to 980 nm.

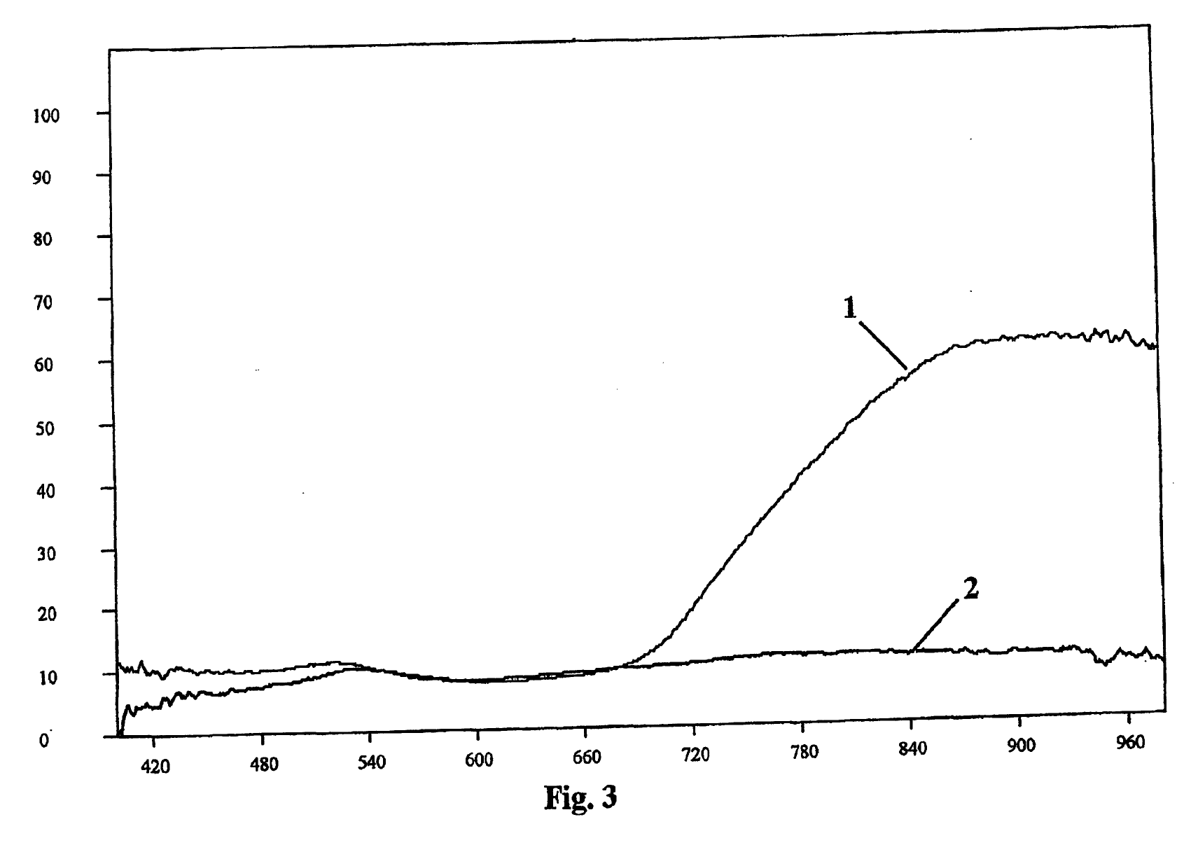

The measurement results are shown in FIG. 3, curve (1), on a scale of 0 to 100%, as the reflection over the wavelength. The increased reflection in the near infrared range is clearly recognisable.

### Comparative Example for 3

A green bitumen shingle of the firm Vedaform was spectrally measured in the wavelength range of 400 to 980 nm. The measurement results are shown in FIG. 3, curve (2), as the reflection across the wavelength. They show a clearly lower reflection in the near infrared wavelength range than is the case for the green colour according to the invention in FIG. 3, curve (1). This roof shingle clearly heats up more than the green coloured roof shingle according to the invention when exposed to solar radiation.

### Example 4

A grey colour according to the invention was mixed according to the following formulation:

| | |
|---|---|
| 50.00 g | water with 2% Tylose MH 2000 of the firm Clariant |
| 30.00 g | Mowilith DM 611 of the firm Hoechst |
| 00.30 g | anti-foaming agent Byk 024 of the firm Byk Chemie |
| 00.30 g | pigment disperser N of the firm BASF |
| 80.00 g | zirconium silicate of the firm Wema |
| 60.00 g | Ropaque OP 62 polymer pigment of the firm Rohm and Haas |
| 05.00 g | Copo wax dispersion 312 W of the firm Coating Products |
| 20.00 g | Blanc Fixe HD 80 of the firm Solvay |
| 40.00 g | Ferro PK 0032 white of the firm Ferro |
| 01.99 g | Expancel 461 DE 20 of the firm Akzo Nobel |
| 01.70 g | black colour paste comprised of: |
| | 20 parts Paliogen black L0086 of the firm BASF |
| | 80 parts butyl glycol |
| | 11 parts QWD 0108 Magenta of the firm Sun Chemical |

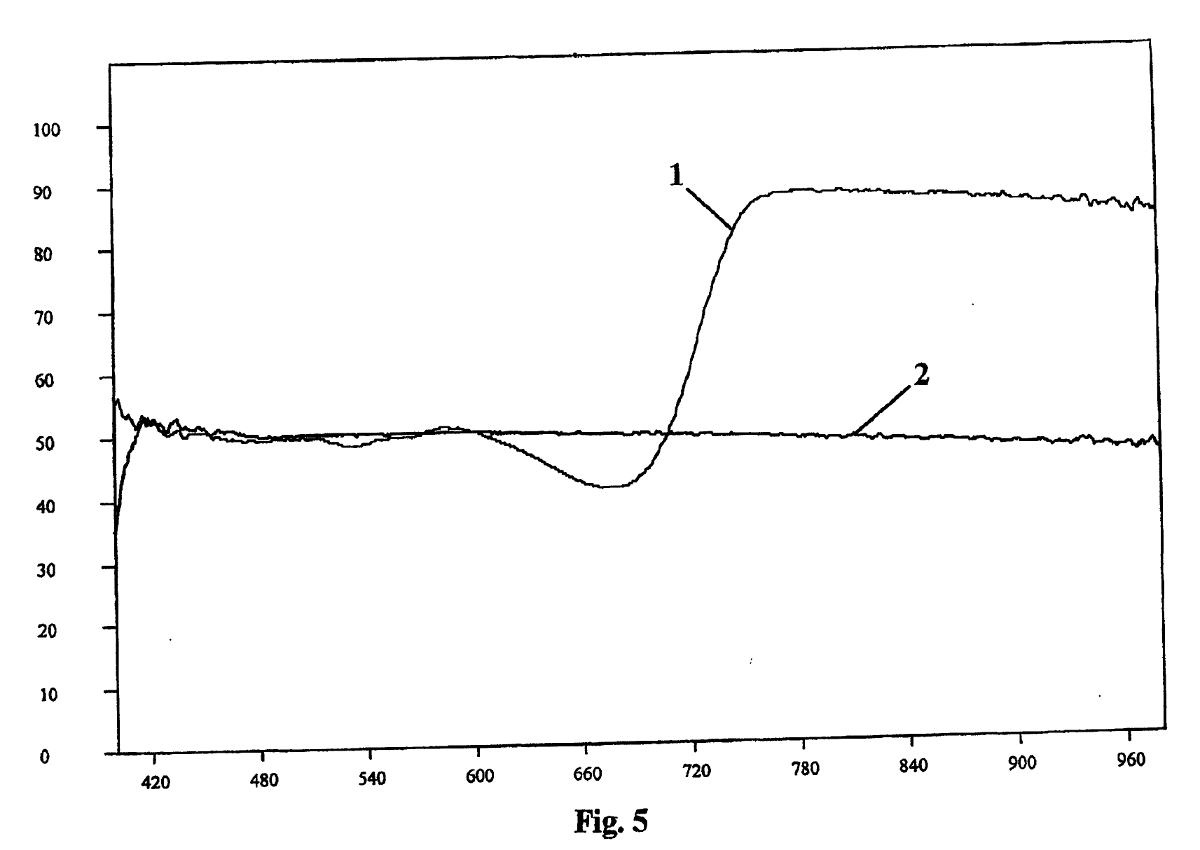

The colour was applied to a common laboratory black/white colour testing card using a coating dumbbell at a layer thickness of 150 μm and was spectrally measured against the black background of the colour testing card in the wavelength range of 300 to 450 nm. The measurement results are shown in FIG. 4, curve (1); the reflection of the grey colour according to the invention is over 50% in the UV range on a scale of 0 to 100%. The reflection in the visible range and the near infrared range of the spectrum is shown in FIG. 5, curve (1) for wavelengths of 400 to 980 nm.

### Comparative Example for Example 4

100.00 g of a commercial white wall colour of the firm ispo GmbH called “Lotusan” was coloured in the same grey tones as the colour according to the invention in Example 4 using 1 g of an oxide black paste based on a commercial oxide black of the firm Bayer. The colour was then applied to a common laboratory black/white colour testing card using a coating dumbbell at a layer thickness of 150 μm and was spectrally measured against the black background of the colour testing card in the wavelength range of 300 to 450 nm. The measurement results are shown in FIG. 4, curve (2). Owing to the great absorption by titanium dioxide, which is usually used as the white pigment in commercial colours, the reflection of the toned, commercial colours in the UV range is below 30% in parts. It can be clearly seen from FIG. 5, curve (2), that the reflection of the grey toned commercial wall colour is also clearly lower in the near infrared range of 720 to over 980 nm than the reflection of the grey colour according to the invention whose measurement result can be seen in FIG. 5, curve (1). The commercial wall colour clearly heats up more when exposed to solar radiation.

### Example 5

A further grey colour according to the invention was mixed according to the following formulation:

| | |
|---|---|
| 50.00 g | water with 2% Tylose MH 2000 of the firm Clariant |
| 30.00 g | binding agent Mowilith DM 771 of the firm Hoechst |
| 00.40 g | anti-foaming agent Byk 024 |
| 80.00 g | zirconium silicate of the firm Wema, Nuremberg |
| 00.30 g | pigment disperser N of the firm BASF |
| 60.00 g | polymer pigment OP62 of the firm Rohm and Haas |
| 09.00 g | Tego Phobe 1500 of the firm Tego Chemie, Essen |
| 20.00 g | Blanc Fixe HD 80 of the firm Solvay |
| 40.00 g | Ferro PK 0032 white of the firm Ferro |
| 02.00 g | Expancel 461 DE 20 of the firm Akzo Nobel |
| 01.45 g | blue pigment 214 of the firm Shepherd |
| 04.00 g | brown pigment 157 of the firm Shepherd |
| 03.30 g | Paliogen Black L0086 of the firm BASF |

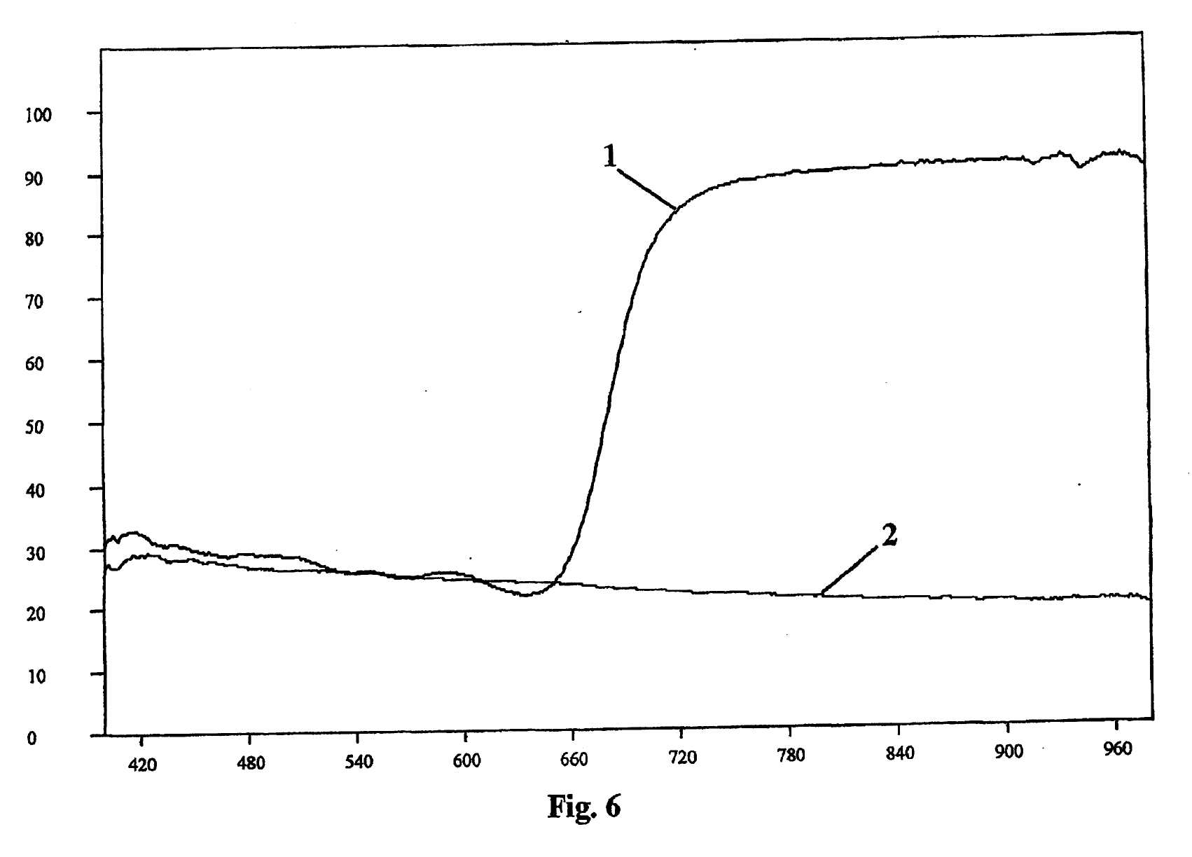

The colour was applied to a common laboratory black/white colour testing card using a coating dumbbell at a layer thickness of 250 μm and was spectrally measured against the black background of the colour testing card in the wavelength range of 400 to 980 nm. The measurement results are shown in FIG. 6, curve (1) as spectral reflection over the wavelength.

### Comparative Example for 5

The colour chart of a commercial exterior wall colour “Drumhill Gray” of the firm Sonneborn USA was spectrally measured in the wavelength range of 400 to 980 nm. The measurement results are shown in FIG. 6, curve (2). The commercial grey wall colour shows a clearly lower reflection in the near infrared range than is the case for the grey colour according to the invention. This colour clearly heats up more than the grey colour according to the invention when exposed to solar radiation.

Comparison of Heating During Solar Radiation

Equally sized samples of the colours from Example 5 were stuck on a styropore plate and exposed to solar radiation at 98 000 Lx. The temperatures of the samples were measured using a radiation thermometer. The following temperatures resulted:

| | |
|---|---|
| Grey according to the invention | 44° C. |
| Commercial “Drumhill Gray” | 58° C. |

1. A coating having a negligible solar absorption, characterised by the following features:
a) a binding agent and/or a combination of binding agents which have a transparency of greater than 60% in the wavelength range of ultraviolet and visible light and in the near infrared wavelength range, i.e. 300 to 2500 nm, and which have a transparency of less than 70% in the thermal infrared wavelength range of 5 to 50 μm.
b) first pigments which have a transparency of greater than 70% in the wavelength range of 300 to 2500 nm, the particle size of which is selected in such a way that they have a backscattering of greater than 70% in the near infrared wavelength range of 700 to 1500 nm, and which have an absorption of greater than 40% in the thermal infrared range of 5 to 50 μm.
c) second pigments which absorb spectral-selectively in the visible light wavelength range of 400 to 700 nm and/or absorb more than 50% in the entire visible light wavelength range of 400 to 700 nm, and which have a transparency of greater than 50% in the near infrared wavelength range of 700 to 1500 nm and have an absorption of greater than 40% in the thermal infrared range of 5 to 50 μm.
d) and/or third pigments which absorb spectral-selectively in the spectral range of visible light of 400 to 700 nm and/or absorb more than 50% in the entire visible light wavelength range of 400 to 700 nm, and which are reflective themselves in the near infrared spectral range with a reflection of greater than 50% and have an absorption of greater than 40% in the thermal infrared range of 5 to 50 μm.
e) fillers for reducing the refractive index of the binding agent matrix consisting of hollow microspheres filled with a gas or air and/or air pockets in the binding agent, the particle and/or air pocket sizes of which are selected such that they have a low backscattering of less than 70% in the visible light wavelength range of 400 to 700 nm, that the backscattering of the first pigments increases by 10% in the near infrared wavelength range of 700 to 1500 nm, and which have an absorption of greater than 40% in the thermal infrared range of 5 to 50 μm.

2. A coating having a negligible solar absorption according to claim 1, characterised in that the binding agent is selected from
a) the group of solvent-containing binding agents which includes acrylates, styrene acrylates, polyvinyls, polystyrenes and styrene copolymers, alkyd resins, saturated and unsaturated polyesters, hydroxide functional polyesters, melamine formaldehyde resins, polyisocyanate resins, polyurethanes, epoxide resins, fluoropolymers and silicones, chlorosufonated polyethylenes, fluorinated polymers, fluorinated acryl copolymers, fluorosilicones, plastisols, PVDF and mixtures hereof.
b) the group of aqueous binding agents which includes the group of water-soluble binders of alkyds, polyesters, polyacrylates, epoxides and expoxide esters, from the group of aqueous dispersions and emulsions which includes dispersions and emulsions on the basis of acrylate, styrene acrylate, ethylene acrylic acid copolymers, methacrylate, vinylpyrrolidone vinyl acetate copolymers, polyvinyl pyrrolidones, polyisopropyl acrylate, polyurethane, silicone, wax dispersions on the basis of polyethylene, polypropylenes, Teflon®, synthetic waxes, fluorinated polymers, fluorinated acryl copolymer in an aqueous solution, fluorosilicones and mixtures hereof.

3. A coating having a negligible solar absorption according to claims 1 and 2, characterised in that the binding agent has a transparency of greater than 70% in the visible light wavelength range of 300 to 700 nm and a transparency of less than 60% in the thermal infrared wavelength range of 5 to 50 μm.

4. A coating having a negligible solar absorption according to claim 1, characterised in that the first pigments are selected from the group of inorganic pigments, from the group of metal oxides, metal sulphates, metal sulphides, metal fluorides, metal silicates, metal carbonates and mixtures hereof.

5. A coating having a negligible solar absorption according to claims 1 and 4, characterised in that the first pigments are selected from the group of degradable materials selected from calcium carbonate, magnesium carbonate, zirconium silicate, zirconium oxide, aluminium oxide, natural barium sulphate and mixtures hereof.

6. A coating having a negligible solar absorption according to claims 1, 4 and 5, characterised in that the refraction index of the first pigments is greater than 1.5, preferably greater than 1.7.

7. A coating having a negligible solar absorption according to claims 1, 4, 5 and 6, characterised in that the particle size of the first pigments is between 0.9 and 3.1 μm, in particular 2 μm.

8. A coating having a negligible solar absorption according to claim 1, characterised in that the second pigments are selected from the group of organic pigments, selected from the group of azo pigments, selected from monoazo pigments, disazo pigments, β-naphtol pigments, naphtol AS pigments, coated azo pigments, benzimidazolone pigments, disazo condensation pigments, metal complex pigments, isoindolinone and isoindoline pigments, selected from the group of polycyclic pigments, selected from phthalocyanine pigments, quinacridone pigments, perylene and perinone pigments, thioindigo pigments, anthraquinone pigments, anthrapyrimidine pigments, flavanthrone pigments, pyranthrone pigments, anthanthrone pigments, dioxazine pigments, triaryl carbonium pigments, quinophthalone pigments, and diketopyrrolopyrrol pigments.

9. A coating having a negligible solar absorption according to claim 1, characterised in that the third pigments are selected from the group of inorganic pigments, selected from the group of metal oxides and hydroxides, in particular iron oxides, from cadmium, bismuth, chromium, ultramarine and iron blue pigments, from the group of rutile and spinel mixed phase pigments and coated, lamellar mica pigments.

10. A coating having a negligible solar absorption according to claims 1 and 9, characterised in that the particle size of the third pigments is between 0.7 and 2.9 μm, in particular between 0.9 and 1.8 μm.

11. A coating having a negligible solar absorption according to claim 1, characterised in that the fillers are hollow microspheres made of an organic and/or inorganic material which has a transparency of greater than 70% in the wavelength range of 300 to 1500 nm.

12. A coating having a negligible solar absorption according to claims 1 and 11, characterised in that the particle size of the hollow microspheres is between 10 and 100 μm, in particular between 20 and 40 μm.

13. A coating having a negligible solar absorption according to claims 1, 11 and 12, characterised in that the hollow microspheres are selected from plastic and/or glass.

14. A coating having a negligible solar absorption according to claim 1, characterised in that hollow microspheres of plastic are selected, which are present in an aqueous suspension and which form a hollow space following drying.

15. A coating having a negligible solar absorption according to claims 1 and 14, characterised in that the particle size of the hollow microspheres is between 0.3 and 1 μm.

16. A coating having a negligible solar absorption according to claim 1, characterised in that the reflection of the coating in the near infrared wavelength range of 800 to 1100 nm is consistently greater than 60%.

17. A coating having a negligible solar absorption according to claim 1, characterised in that the reflection of the coating in the near infrared wavelength range of 800 to 1100 nm is consistently greater than 70%.

18. A coating having a negligible solar absorption according to claim 1, characterised in that the reflection of the coating in the visible light wavelength range of 400 to 700 nm is on average less than 70%, preferably less than 60% and particularly preferred less than 50%.

19. A coating having a negligible solar absorption according to claims 1 and 3, characterised in that binding agents are selected which result in a water-repellent surface following hardening.
